(19) United States
(12) Patent Application Publication
(10) Pub. No.: US 2013/0177749 A1
(43) Pub. Date: Jul. 11, 2013

(54) NANOSTRUCTURES

(71) Applicant: Tufts University, Medford, MA (US)

(72) Inventors: Qiaobing Xu, Somerville, MA (US); Xiaoshu Dai, Watertown, MA (US)

(73) Assignee: Tufts University, Medford, MA (US)

(21) Appl. No.: 13/737,352

(22) Filed: Jan. 9, 2013

Related U.S. Application Data
(60) Provisional application No. 61/584,437, filed on Jan. 9, 2012.

(51) Int. Cl. C01B 33/113; C01D 17/00; C01G 9/04; C22B 3/00; C01G 49/10; C01G 7/00; C01B 25/32; C01G 23/04; C07F 5/00; C01G 55/00

(52) U.S. Cl. CPC C01B 33/113; C07F 5/003; C01D 17/00; C01G 9/04; C01G 55/005; C01G 49/10; C01G 7/00; C01B 25/32; C01G 23/04; C22B 11/04; Y10S 977/888; B82Y 40/00
USPC 428/209; 264/334; 75/343; 428/195.1; 977/888; 977/700; 977/811

(57) ABSTRACT

A method for producing a matrix containing nanostructures. The method includes obtaining a layer having a thickness of 10 nm-100 μm, wherein the layer contains organic macromolecules arranged in a nanopattern, staining the layer with a solution containing a salt so that a portion of the salt is retained in the layer, and removing the organic mcaromolecules from the layer to form a matrix containing nanostructures. Also within the scope of this invention are nanostructures prepared by this method.

### CROSS REFERENCE TO RELATED APPLICATION

This application claims priority to U.S. Provisional Application No. 61/584,437, filed Jan. 9, 2012, the contents of which are hereby incorporated by reference in their entirety.

### BACKGROUND OF THE INVENTION

Structures of a nanometer size exhibit unique properties compared to those having a larger size. For example, metal nanowires manifest quantum phenomena in electron transport. See Hu J., et al., Accounts of Chemical Research, 1999, 32:435. Due to their unique properties, nanostructured metals have wide applications in biomedical sciences, electronics, optics, magnetism, and energy storage. Martin C., Chemistry of Materials, 1996, 8: 1739; Huczko A., Applied Physics, 2000, 70: 365; Smith A. et al., Nat. Nanotechnol. 2009, 4:56-63; Newhouse R., et al., J. Phys. Chem. Letter, 2011, 2:228-235; and Walkey C. et al., Hematology 2009, 1:701.

Nanostructures can be produced by many methods, including inert gas condensation, plasma processing, physical and chemical vapor deposition, electrodeposition, mechanical alloying, rapid solidification, sol-gel, micro-emulsion, spark erosion, and severe plastic deformation. However, all these methods have been limited to laboratory use due to their high costs.

There is a need to develop cost-effective methods for preparing nanostructures formed of metals or non-metals.

### SUMMARY OF THE INVENTION

This invention relates to a method for producing a matrix having metal or non-metal nanostructures.

In one aspect, the method includes obtaining a 10 nm-100 μm-thick layer of organic macromolecules arranged in a nanopattern, placing the layer on a substrate, staining the layer with a solution containing ions ([UO₂]²⁺, Rb⁺, Ca²⁺, Zn^{2+, Pt}²⁺, Fe³⁺, Au³⁺, Ti⁴⁺, Si⁴⁺, titanate, silicate, or a mixture thereof) so that a portion of ions are retained in the layer, and removing the organic macromolecules from the layer to form a matrix having metal salt and non-metal salt nanostructures. Molecules are arranged in a nanopattern if a substantial portion (e.g., 80% or 90%) of them is orientated in such a manner that they form a certain pattern on a nanoscale. The nanostructures produced by this method are metal salt nanostructures.

In another aspect, the method can further include a step of treating the layer with a reducing agent to reduce the metal retained salt in the layer to a metal. The reducing step can be performed either between the staining step and the removing step or after the removing step. The nanostructures produced by this method are metal nanostructures.

In still another aspect, the method can further include heating the layer to decompose an oxygen-containing metal salt to a metal oxide. The heating step can be performed either between the staining step and the removing step or after the removing step. The nanostructures produced by this method are metal oxide nanostructures.

In a further aspect, the method can further include replacing the solution containing a calcium salt with a phosphate solution. The replacing step is performed between the staining step and the removing step. The nanostructures produced by this method are calcium phosphate nanostructures.

In yet another aspect, the method can further include (1) replacing the solution with an acidic solution and (2) heating the layer to decompose titanate and silicate to titanium oxide and silicon oxide, respectively. The replacing step is performed between the staining step and the removing step. The heating step can be performed either between the replacing step and the removing step or after the removing step. The nanostructures produced by this method are titanium oxide or silicon oxide nanostructures.

The organic macromolecule-containing layer can be obtained by sectioning tendon, muscle, bone, cartilage, or diatom. The sectioning instrument can be a microtome or ultramicrotome. Further, the organic macromolecules (e.g., collagen in tendon or actin in muscle) can be removed by plasma etching. For example, the layer can be subjected to oxygen plasma or argon plasma to decompose and remove the organic macromolecules.

The substrate is formed of a material that is resistant to acid or base treatments, organic solvents, high heat, and plasma etching. Examples include, but are not limited to, silicon, silicon oxide, and glass.

Also within the scope of this invention are nanostructures prepared by the method described above.

The details of one or more embodiments of the invention are set forth in the description and the drawings below. Other features, objects, and advantages of the invention will be apparent from the detailed description of several embodiments and also from the appending claims.

### BRIEF DESCRIPTION OF THE DRAWINGS

FIG. 1(A) is a schematic diagram showing a process of preparing metal salt nanostructures, FIG. 1(B) is a reversed back-scattering SEM image of collagen nanofibers stained with both UA and lead citrate, and FIG. 1(C) is a SEM image of 2D metal salt nanostructures after removal of the collagen nanofibers using oxygen plasma etching.

FIGS. 2(A), (B), (C), (D), (E), and (F) are SEM images of nanostructures of RbNO₃, ZnCl₂, PtCl₂, PdCl₂, FeCl₃, and HAuCl₄, respectively, prepared by the method of this invention.

FIG. 3(A) is a SEM image of collagen nanofibers in a 20 μm-thick tendon slice, FIG. 3(B) is a SEM image of 3D foam-like nanostructures of the same tendon slice after stained with PtCl₂ and etched with oxygen plasma, and FIG. 3(C) is an EDX spectrum of the 3D foam-like nanostructures.

FIGS. 4(A) and 4(B) are a SEM image and an EDX spectrum of 3D foam-like Pd nanostructures, respectively, and FIG. 4(C) and 4(D) are a SEM image and an EDX spectrum of 3D foam-like Pt nanostructures, respectively.

### DETAILED DESCRIPTION OF THE INVENTION

This invention includes a method of producing a matrix having nanostructures. A nanostructure refers to a structure that contains atomic metal, metal salt, metal oxide, silicon oxide, calcium phosphate, or other suitable materials, and has a size in a nanoscale (e.g., 1-1000 nm).

To practice the method of this invention, one first prepares a 10 nm-100 μm-thick layer that contains organic macromolecules. The organic macromolecules are so arranged that they constitute a matrix having voids, pores, or slits at a nanometer scale (10-1000 nm). See, e.g., Paulsen N., et al., Proceedings of the National Academy of Sciences 2003, 100, 12075-12080.

Organic macromolecules are molecules containing a carbon-containing backbone and having a molecular weigh greater than 200 (or greater than 500). These molecules are either naturally occurring biomolecules (such as collagen or actin) or synthesized materials (such as polyalcohol or polyamine).

In one embodiment, the organic macromolecule-containing layer is obtained from natural sources containing protein fibers, e.g., tendon (containing collagen fibers) and muscle (containing actin filaments). The natural sources are cut to obtain small blocks and decellularized. See J. Physiol. 567.3 (2005) pp 1021-1033. The order of the cutting and decellularization steps can alter.

Decellularization can be accomplished using one or more decellularization agents, e.g., detergents, emulsification agents, proteases, and ionic solutions. See U.S. Pat. No. 6,962,814 for suitable decellularization agents and conditions. Decellularization preferably does not cause gross alteration in the structure of the tissue or cause substantial alteration in its biomechanical properties. The effects of decellularization on structure can be evaluated by light microscopy, ultrastructural examination, or both.

Preferably, the decellularized tissue, after removal from the solution used in the decellularization, is washed in a physiologically appropriate solution, e.g., PBS or tissue culture medium. The washing removes the residual decellularization solution that might otherwise cause deterioration of the decellularized tissue.

The blocks are then sectioned into 2D films having a predetermined thickness of 10-1000 nm with an ultramicrotome or 3D slices having a predetermined thickness of 1-100 μm with a microtome. See Junqueira, L. et al., A Concise medical library for practitioner and student, Lange Medical Publications, 1975 and Glauert, A. et al., M., Practical methods in electron microscopy. North-Holland Pub. Co., 1972. For example, the collagen blocks are embedded in an araldite epoxy matrix and sectioned using ultramicrotome to obtain 2D films, or they are fixed with formaldehyde, embeded in paraffin, and sectioned using microtome to obtain 3D slices. The collagen blocks can be sectioned at any angle relative to the collagen fibers in the blocks. In one embodiment, the collagen blocks are sectioned at a direction parallel to the orientation of the collagen fibers in the blocks so that the fibers extend along the obtained films or slices. In another embodiment, they are sectioned at a direction perpendicular to the orientation of the collagen fibers in the blocks so that the fibers extend cross the obtained films or slices.

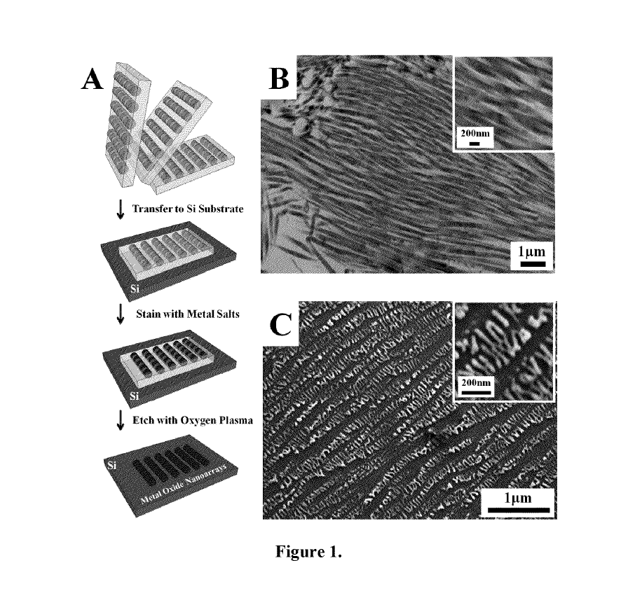

The obtained films or slices can be placed on a substrate to facilitate handling of the films or slices and their subsequent products. See FIG. 1(A). The films or slices are stained with a solution containing a salt. See also FIG. 1(A). The solvent used in the solution is either water or an organic solvent, e.g., methanol, ethanol, and acetone. The salt can be a metal (e.g., Ca, Ti, V, Cr, Mn, Fe, Co, Ni, Cu, Zn, Mo, W, U, Ag, Pd, Pt, and Au) salt, which is preferably soluble in the solvent. Examples of the metal salt include, but are not limited to, halides (e.g., fluoride, chloride, and iodide), nitrates, nitrites, sulfates, sulfites, carbonates, or acetates of Ca, Ti, V, Cr, Mn, Fe, Co, Ni, Cu, Zn, Mo, W, U, Ag, Pd, Pt, and Au. The salt can also be a titanate salt (e.g., triethanolamine titanate) and a silicate salt (e.g., sodium silicate). The concentration of the salt and the pH value of the solution can be adjusted to facilitate the staining process. The films and slices can be immersed in a salt solution for a length of time sufficient to effect absorption of the salt solution into the films or slices. As another example, the films or slices are sprayed with a salt solution and allowed to sit for sufficient time to effectuate the absorption.

Either positive staining or negative staining can be used to practice the method of this invention. Positive staining is a process in which ions react with the macromolecules in a layer and the unreacted solution is removed afterwards. Negative staining is a process where the excess ions are not removed and are allowed to remain in and on a layer (M. A. Hayat, Positive staining for electron microscopy, Van Nostrand Reinhold Co., New York, 1975; M. A. Hayat, S. E. Miller, Negative staining, McGraw-Hill Pub. Co., New York, 1990).

As illustrated in the Scheme of FIG. 1(A), after the staining, the films or slices can be etched to remove the organic contents. For example, they are subject to plasma treatment, e.g., oxygen plasma and argon plasma. The organic contents are removed by the treatment, while the salt remains and defines nanostructures (Xu, et al., ACS Nano, 2007,1, 215-227).

To prepare transition metal element nanostructures, one can reduce a transitional metal salt with a reducing agent. Examples of a suitable reducing agent include, but are not limited to, H₂ (under catalytic condition, e.g., Pd/C), sodium, sodium amalgam, magnesium, sodium borohydride, sulfite, hydrazine, zinc-mercury amalgam, lithium aluminium hydride, diisobutylaluminum hydride, oxalic acid, formic acid, ascorbic acid, phosphites, dithiothreitol, and Fe²⁺ salts. The reducing step can be conducted after the removing step. Alternatively, it can be conducted after the staining step and before the removing step. The thus-obtained product is a matrix, 10 nm-100 μm in thickness, containing atomic metal nanostructures.

To prepare metal oxide nanostructures, one can use a solution containing a metal oxygen-containing salt (e.g., a metal nitrate, a metal sulfate, a metal carbonate, and a metal acetate) in the staining step and thermally decompose the oxygen-containing metal salt, the decomposing step being conducted after the staining step and before the removing step or after the removing step. Alternatively, one can oxidize metal element nanostructures prepared in the manner described above with an oxidizing agent.

Examples of a suitable oxidizing agent include, but are not limited to, sulfuric acid, nitric acid, permanganate, dichromate, chlorate, hypochlorite, peroxide, oxygen, and ozone. This oxidizing step can be conducted after the reducing step. The thus-obtained product is a matrix, 10 nm-100 μm in thickness, containing metal oxide nanostructures.

To prepare titanium oxide and silicon oxide nanostructures, one can further include, after the staining step with triethanolamine titanate or sodium silicate and before the removing step, an acidifying step (i.e., replacing the solution with an acidic solution) and a heating step. To prepare calcium phosphate nanostructures, one can further include, after the staining step with a Ca²⁺ salt and before the removing step, a calcium phosphate-forming step (i.e., replacing the solution with a phosphate solution).

Described in detail above is a method of preparing a matrix containing nanostructures using a collagen template. One skilled in the art would be able to follow the above method with modifications to prepare matrices having metal nanostructures using other naturally occurring templates or synthesized templates, e.g., muscle, polypeptide, or nucleic acid. For example, DNA origami can be used as template for metal staining It is mostly positive staining After staining (and reducing), the nanostructures from DNA origami can be transferred to nanostructures of metals, salts, oxides, and calcium phosphate.

Without further elaboration, it is believed that one skilled in the art can, based on the disclosure herein, utilize the present invention to its fullest extent. The following specific examples are, therefore, to be construed as merely descriptive, and not limitative of the remainder of the disclosure in any way whatsoever. All publications cited herein are incorporated by reference.

### Fabrication of 2D Arrays of Nanostructures of Metal Salts

Decellularized tendon was fixed in 4% formaldehyde and dehydrated using gradient ethanol solutions. To make submicron sections, the processed tissue was embedded in an araldite epoxy matrix and sliced along the longitude orientation of collagen fibers in the tendon using an ultramicrotome. The slices were transferred to a glass or SiO₂/Si solid substrate.

The slices were stained with 2% w/w uranyl acetate followed by 2% lead citrate for 12 hrs. They were rinsed with deionized (DI) water for 3 mins. The sections were then air-dried and the band structure of the collagen nanofibers was observed. The reversed back scattering SEM image is shown in FIG. 1(B). The dark bands indicate the electron dense areas as a result of the uptake of metal ions on the charged side-chains of arginine, lysine, hydroxylysine, and histidine residues of a collagen molecule. The light regions are the areas where hydrophobic amino is located and metal ion binding is inhibited. Those regions were not stained with metal salt.

FIG. 1(C) shows the resulted parallel band structures of uranyl acetate (UA), with ˜200 nm in length and ˜70 nm in width, corresponding to the diameter of the collagen fiber and the constant axial displacement D, respectively. The UA band nanostructures are aligned parallel to the orientation of original collagen nanofibers.

RbNO₃, ZnCl₂, PtCl₂, PdCl₂, FeCl₃, and HAuCl₄ nanostructures were also used to prepared metal nanostructures.

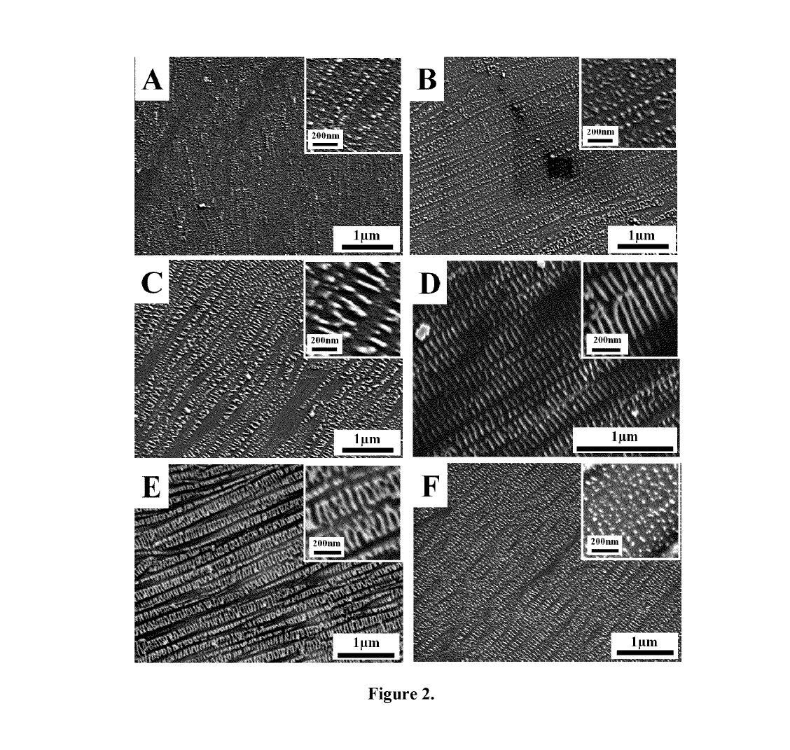

FIG. 2 shows SEM images of the resulting nanostructures from tendon slices (˜70 nm thick) after the staining and plasma treatment. Similarly, all of the samples had band structures. The efficiency of staining correlates to the valence of ions. The multivalent ions, such as Fe³⁺, Pd²⁺, Pt²⁺, had better staining than the monovalent ions, such as Rb⁺ and AuCl₄⁻. This was probably attributed to stronger electrostatic interaction of the former with the charged protein backbone. The collagen nanofibers stained with Pd²⁺ and Pt²⁺ were better than those stained with Zn²⁺ or Fe³⁺, which indicates that the coordination interaction of the metal ions with the amino acid side chain also played a role in the positive staining process.

### Fabrication of 3D Arrays of Nanostructures of Metal Salts

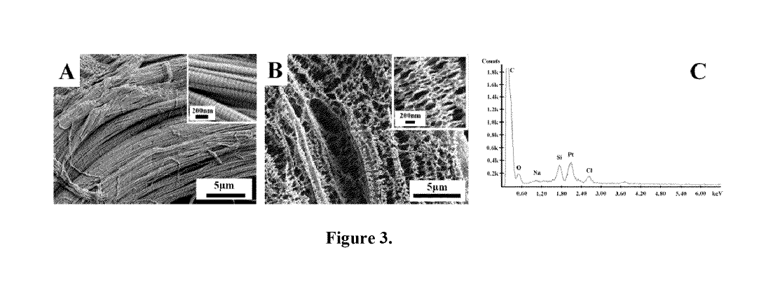

A piece of decellularized formaldhyde-fixed tendon was embedded in paraffin. It was cut along the longitude orientation of collagen nanofibers using a microtome to make 20 μm thick sections. After the slices were placed on a glass slide, the paraffin was removed using xylene and the tendon was rehydrated using a series of gradient ethanol solutions. The resulting rehydrated tendon contained paralleled collagen fibers having diameters approximately 200 nm. See FIG. 3(A).

The collagen fibers were stained by covering the tendon slice with approximately 1 ml PtCl₂ solution. After one hour, the tissue slices were rinsed thoroughly under stream of DI water for 3 mins. The stained tissue samples were then dried in air in a fume hood for 12 hrs. The collagen was removed by exposing the stained tendon slices under oxygen plasma (25 mA) for 30 mins. The sample's color changed from brownish (after staining) to dark flake-like materials. FIG. 3(B) shows the interconnected and layered band nanostructures thus obtained. Energy Dispersive X-ray was conducted to analyze the composition of the sample. The spectrum shown in FIG. 3(C) indicates the presence of the staining metal salt (Pt and Cl), but no nitrogen (N). Clearly, the protein template was completely removed by oxygen plasma and the nanostructures were made of staining metal salt PtCl₂.

### Fabrication of Metal Nanostructures

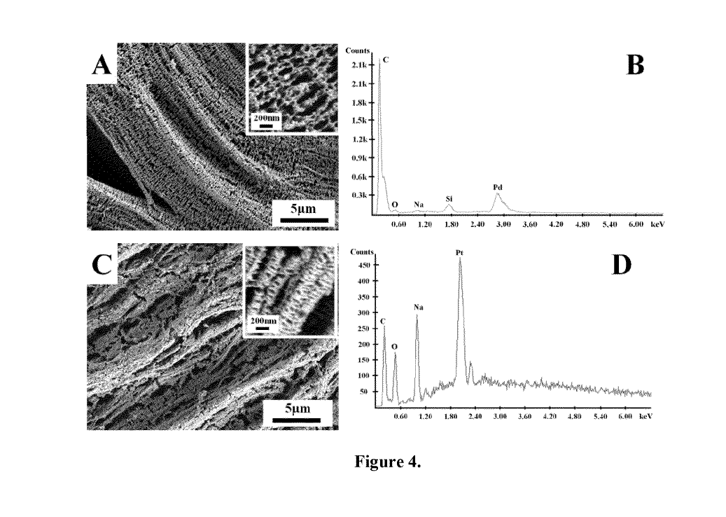

Tendon films/slices (˜70 nm thick or 20 μm thick) were stained with PdCl₂ or H₂PtCl₄ as described above. They were then treated with 2% NaBH₄ aqueous solution to reduce PtCl₂ to Pt. The resulting metal-collagen slices were etched by oxygen plasma to remove the organic contents. The SEM images in FIG. 4(A) and (C) show porous foam-like Pt and Pd nanostructures fabricated by this method, which retained the characteristic band structures observed in stained collagen. The EDX spectra in FIGS. 4(B) and 4(D) do not show the chloride peaks, indicating the complete conversion of metal salts to metals.

### OTHER EMBODIMENTS

All of the features disclosed in this specification may be combined in any combination. Each feature disclosed in this specification may be replaced by an alternative feature serving the same, equivalent, or similar purpose. Thus, unless expressly stated otherwise, each feature disclosed is only an example of a generic series of equivalent or similar features.

From the above description, a person skilled in the art can easily ascertain the essential characteristics of the present invention, and without departing from the spirit and scope thereof, can make various changes and modifications of the present invention to adapt it to various usages and conditions. Thus, other embodiments are also within the claims.

What is claimed is:

1. A method for producing a matrix having nanostructures, comprising obtaining a layer of organic macromolecules arranged in a nanopattern, wherein the layer has a thickness of 10 nm-100 μm,
placing the layer on a substrate,
staining the layer with a solution containing a salt so that a portion of the salt is retained in the layer, and
removing the organic macromolecules from the layer to form a matrix having nanostructures.

2. The method of claim 1, wherein the layer is obtained by sectioning tendon, muscle, bone, cartilage, or diatoms.

3. The method of claim 2, wherein the layer is obtained by sectioning tendon or muscle.

4. The method of claim 3, wherein the layer is obtained by sectioning tendon with microtome or ultramicrotome.

5. The method of claim 1, wherein the salt is a metal salt.

6. The method of claim 5, further comprising, after the staining step and before the removing step, treating the layer with a reducing agent to reduce the metal salt retained in the layer to a metal.

7. The method of claim 6, wherein the organic layer has a thickness of 10-1000 nm.

8. The method of claim 7, wherein the metal salt is a salt of [UO₂]²⁺, Rb⁺, Zn²⁺, Pt²⁺, Fe³⁺, Au³⁺, or a mixture thereof.

9. The method of claim 8, wherein the organic macromolecules are removed by plasma etching in the removing step.

10. The method of claim 9, wherein the metal salt is a salt of [UO₂]₂₊.

11. The method of claim 6, wherein the layer has a thickness of 1-100 μm.

12. The method of claim 11, wherein the metal salt is a salt of [UO₂]²⁺, Rb⁺, Zn²⁺, Pt²⁺, Fe³⁺, Au³⁺, or a mixture thereof.

13. The method of claim 12, wherein the organic macromolecules are removed by plasma etching in the removing step.

14. The method of claim 13, wherein the metal salt is a salt of [UO₂]²⁺.

15. The method of claim 1, wherein the layer has a thickness of 10-1000 nm.

16. The method of claim 1, wherein the layer has a thickness of 1-100 μm.

17. The method of claim 1, wherein the salt is a salt of [UO₂]²⁺, Rb⁺, Zn²⁺, Pt²⁺, Fe³⁺, Au³⁺, or a mixture thereof.

18. The method of claim 1, wherein the organic macromolecules are removed by plasma etching in the removing step.

19. The method of claim 5, further comprising, after the removing step, treating the layer with a reducing agent to reduce the metal salt retained in the layer to a metal.

20. The method of claim 5, wherein the metal salt is an oxygen-containing metal salt.

21. The method of claim 20, wherein the oxygen-containing metal salt is a metal nitrate, a metal nitrite, a metal sulfate, a metal sulfite, a metal carbonate, or a metal acetate.

22. The method of claim 21, further comprising, after the staining step and before the removing step, heating the layer to decompose the oxygen-containing metal salt to a metal oxide.

23. The method of claim 5, wherein the metal salt is a calcium salt.

24. The method of claim 23, further comprising, after the staining step and before the removing step, replacing the solution with a phosphate solution.

25. The method of claim 1, wherein the salt is triethanolamine titanate or sodium silicate.

26. The method of claim 25, further comprising, after the staining step and before the removing step,
replacing the solution with an acidic solution, and
heating the layer to decompose titanate and silicate to titanium oxide and silicon oxide, respectively.

27. Nanostructures obtained by a process which comprises:
obtaining a layer organic macromolecules arranged in a nanopattern, wherein the layer has a thickness of 10 nm-100 μm,
placing the layer on a substrate,
staining the layer with a solution containing a salt so that a portion of the metal salt is retained in the layer, and
removing the organic macromolecules from the layer.

28. The nanostructures of claim 27, wherein the salt is a metal salt.

29. The nanostructures of claim 28, wherein the process further comprises, after the staining step and before the removing step, treating the layer with a reducing agent to reduce the metal salt retained in the layer to a metal.

30. The nanostructures of claim 28, wherein the metal salt is an oxygen-containing metal salt.

31. The nanostructures of claim 30, wherein the oxygen-containing metal salt is a metal nitrate, a metal nitrite, a metal sulfate, a metal sulfite, a metal carbonate, or a metal acetate.

32. The nanostructures of claim 31, further comprising, after the staining step and before the removing step, heating the layer to decompose the oxygen-containing metal salt to a metal oxide.

33. The nanostructures of claim 28, wherein the salt is a calcium salt.

34. The nanostructures of claim 33, further comprising, after the staining step and before the removing step, replacing the solution with a phosphate solution.

35. The nanostructures of claim 27, wherein the salt is triethanolamine titanate or sodium silicate.

36. The nanostructures of claim 35, further comprising, after the staining step and before the removing step,
replacing the solution with an acidic solution, and
heating the layer to decompose titanate and silicate to titanium oxide and silicon oxide, respectively.
